(19) United States
(12) Patent Application Publication
(10) Pub. No.: US 2013/0165315 A1
(43) Pub. Date: Jun. 27, 2013

(54) METHOD OF FORMING A HYDROCARBON CRACKING CATALYST

(71) Applicants: SULAIMAN S. AL-KHATTAF, DHAHRAN (SA); RABINDRAN JERMY BALASAMY, DHAHRAN (SA); MOHAMMED ABDUL BARI SIDDIQUI, DHAHRAN (SA); ABDULLAH M. AITANI, DHAHRAN (SA); MIAN RAHAT SAEED, DHAHRAN (SA)

(72) Inventors: SULAIMAN S. AL-KHATTAF, DHAHRAN (SA); RABINDRAN JERMY BALASAMY, DHAHRAN (SA); MOHAMMED ABDUL BARI SIDDIQUI, DHAHRAN (SA); ABDULLAH M. AITANI, DHAHRAN (SA); MIAN RAHAT SAEED, DHAHRAN (SA)

(73) Assignee: KING FAHD UNIVERSITY OF PETROLEUM AND MINERALS, DHAHRAN (SA)

(21) Appl. No.: 13/338,177

(22) Filed: Dec. 27, 2011

(51) Int. Cl. B01J 29/40

(52) U.S. Cl. 502/69

(57) ABSTRACT

The method of forming a hydrocarbon cracking catalyst provides a method of varying or tuning the mesophase MCM-41 or microporous ZSM-5 properties in biporous ZSM-5/MCM-41 composites, depending on the requirements of the intended application. The method includes the steps of performing a surfactant-mediated hydrolysis of ZSM-5 to form a solution, and then adjusting the pH of the solution to selectively tune the microporous and mesoporous properties of the final ZSM-5/MCM-41 catalyst product. Following tuning, soluble aluminosilicates are hydrothermically condensed to form a mesoporous material over the remaining ZSM-5 particles to form the ZSM-5/MCM-41 composite. The ZSM-5/MCM-41 composite may be used as a hydrocarbon cracking catalyst for cracking gas, oil or the like.

### BACKGROUND OF THE INVENTION

1. Field of the Invention

The present invention relates to fluid catalytic cracking (FCC), and particularly to the manufacture of a ZSM-5/MCM-41 composite catalyst for use with FCC processes.

2. Description of the Related Art

Fluid catalytic cracking (FCC) is commonly used to produce propylene. In the FCC process, heavy feedstocks, such as vacuum gas oil or residual oil, are cracked into value-added lighter products, such as gasoline. Currently, about 28% of the world's propylene is supplied by refinery FCC operations, and 63% is co-produced from thermal steam cracking of naphtha or other feedstocks. The remainder is produced using metathesis or propane dehydrogenation processes. Special FCC process designs and catalysts have been developed to selectively increase propylene production, and ultimately to provide a technology for full light olefins and aromatics petrochemical integration.

The addition of the zeolite ZSM-5 to FCC catalysts has improved propylene yield by offering refiners a high degree of flexibility to optimize the production output of their FCC units. Recent research has indicated the importance of biporous composites for usage with FCC processes, involving both microporous ZSM-5 and MCM-41 as additives in enhancing FCC propylene output. Such biporous materials, however, are typically extremely difficult to produce and previous attempts have been highly labor intensive and cost ineffective.

Thus, a method of forming a hydrocarbon cracking catalyst solving the aforementioned problems is desired.

### SUMMARY OF THE INVENTION

The method of forming a hydrocarbon cracking catalyst provides a method of varying or tuning the mesophase MCM-41 or microporous ZSM-5 properties in biporous ZSM-5/MCM-41 composites, depending on the requirements of the intended application. The method includes the steps of performing a surfactant-mediated hydrolysis of ZSM-5, through gradual heating, to form a solution, and then adjusting the pH of the solution to selectively tune the microporous and mesoporous properties of the final ZSM-5/MCM-41 catalyst product. Following tuning, soluble aluminosilicates are hydrothermically condensed to form. a mesoporous material over the remaining ZSM-5 particles to form the ZSM-5/MCM-41 composite. The ZSM-5/MCM-41 composite may be used as a hydrocarbon cracking catalyst for cracking gas, oil or the like.

The zeolitic disintegration may be single or composed of a mixture of two zeolites, such as ZSM-5 and Beta, ZSM-5 and HY, or ZSM-5 and mordenite. This leads to biporous (micro/meso) or triporous composites (micro-micro-mesoporous) after the formation of MCM-41 in the final step. The ZSM-5/MCM-41 composite produced by this method shows high hydrothermal stability.

These and other features of the present invention will become readily apparent upon further review of the following specification and drawings.

### BRIEF DESCRIPTION OF THE DRAWINGS

FIG. 1A is a graph showing x-ray diffraction intensity as a function of angle for a conventional AlMCM-41 sample.

FIG. 1B is a graph showing x-ray diffraction intensity as a function of angle for a conventional ZSM-5 sample.

FIG. 1C is a graph showing x-ray diffraction intensity as a function of angle for a ZSM-5/MCM-41 composite with high macroporous character produced by the method of forming a hydrocarbon cracking catalyst according to the present invention.

FIG. 1D is a graph showing x-ray diffraction intensity as a function of angle for a ZSM-5/MCM-41 composite with biporous character produced by the method of forming a hydrocarbon cracking catalyst according to the present invention.

FIG. 1E is a graph showing x-ray diffraction intensity as a function of angle for a ZSM-5/MCM-41 composite with high mesoporous character produced by the method of forming a hydrocarbon cracking catalyst according to the present invention.

FIG. 1F is a graph showing x-ray diffraction intensity as a function of angle for the ZSM-5/MCM-41 composite with high mesoporous character after steaming the composite.

FIG. 2 is a table illustrating physico-chemical properties of the composites of FIGS. 1A-1F.

FIG. 3A is a graph comparing x-ray diffraction intensity as a function of angle for the ZSM-5/MCM-41 composite with the biporous character and the ZSM-5/MCM-41 composite after steaming the composite.

FIG. 3B is a graph comparing nitrogen adsorption isotherms for the ZSM-5/MCM-41 composite with the biporous character and the ZSM-5/MCM-41 composite after steaming.

FIG. 4 is a graph showing x-ray diffraction intensity as a function of angle for a triporous ZSM-5/mordenite/MCM-41 composite.

FIG. 5 is a table illustrating comparative microactivity test data for various FCC catalysts.

Similar reference characters denote corresponding features consistently throughout the attached drawings.

### DETAILED DESCRIPTION OF THE PREFERRED EMBODIMENTS

The present invention relates to a method of forming a hydrocarbon cracking catalyst that permits controlled varying or tuning of mesophase MCM-41 or microporous ZSM-5 properties in biporous ZSM-5/MCM-41 composites, depending on the requirements of the intended application. The method includes the steps of performing a surfactant-mediated hydrolysis of ZSM-5 to form a solution, and then adjusting the pH of the solution to selectively tune the microporous and mesoporous properties of the final ZSM-5/MCM-41 catalyst product. Following tuning, soluble aluminosilicates are hydrothermically condensed to form a mesoporous material over the remaining ZSM-5 particles to form the ZSM-5/MCM-41 composite. The ZSM-5/MCM-41 composite may be used as a hydrocarbon cracking catalyst for cracking gas, oil or the like.

The zeolitic disintegration may be single or composed of a mixture of two zeolites, such as ZSM-5 and Beta, ZSM-5 and HY, or ZSM-5 and mordenite. This leads to biporous (micro/meso) or triporous composites (micro-micro-mesoporous) after the formation of MCM-41 in the final step. The ZSM-5/MCM-41 composite produced by this method shows high hydrothermal stability.

### Example 1

For purposes of comparison, conventional AlMCM-41 was first synthesized by dissolving 10.6 g of sodium metasilicate and 0.95 g of aluminum nitrate in 60 g of water. This solution was then thoroughly stirred until a clear solution was obtained. 3.36 g of cetyltrimethylammonium bromide (CTAB) was then dissolved in 20.0 g of ethanol, and the mixture of sodium metasilicate and aluminum sulfate was added to the CTAB/ethanol solution drop-wise, The resultant mixture was stirred for 3.0 h, and then the pH of the resulting gel was adjusted to 11.0 with 4.0 N sulfuric acid followed by stirring for 3 h. This homogenous solution was transferred into an autoclave and heated to 140° C. in static conditions for 12 h. The product was then filtered, washed, dried and calcined at 550° C. for 6 h. The resulting AlMCM-41 was ion-exchanged three times with 0.05 M NH4NO3 solution at 80° C. for 2 h, and then calcined at 550° C. for 2 h.

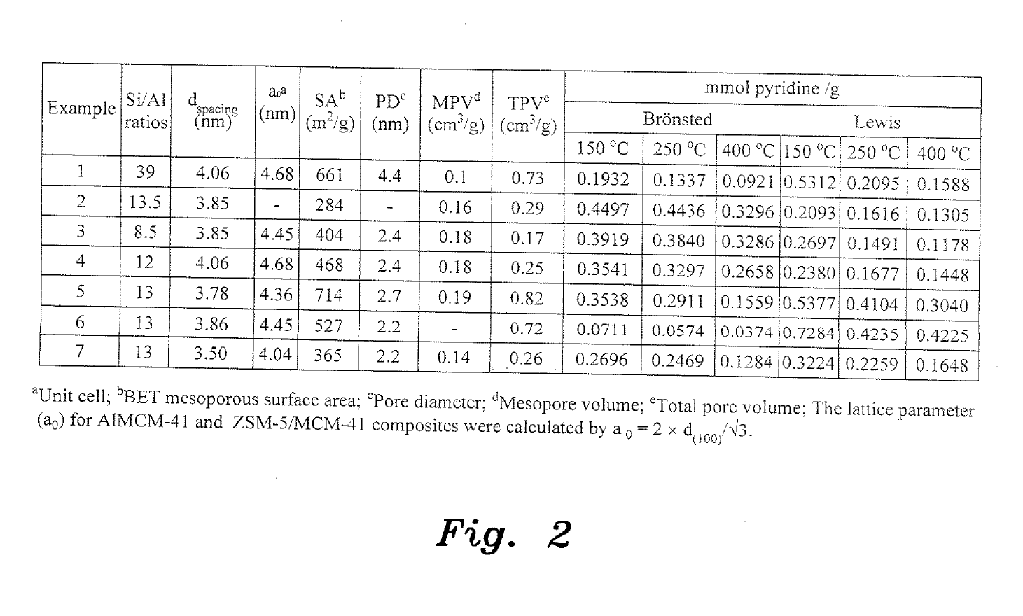

The specific surface area, pore diameter and the total pore volume are shown in Table 1 of FIG. 2. The resulting AlMCM-41 in calcined form had a Si/Al ratio of 39:1 as determined by atomic absorption measurements. The material showed a characteristic x-ray diffraction (XRD) pattern typical to that of mesoporous MCM-41 structures, with a d spacing value of 4.06 nm. The surface area, pore volume and pore diameter as measured by nitrogen adsorption were 661 m²/g, 0.73 cm³/g and 4.4 nm, respectively.

### Example 2

Also for purposes of comparison, a conventional ZSM-5 zeolite sample with a Si/Al ratio of 13.5:1 that is commonly used for the formation of composite additives for fluid catalytic cracking (FCC) processes was obtained from Catal International, Ltd. The surface area and total pore volume of the ZSM-5 sample were 284 m²/g and 0.29 cm³/g, respectively.

### Example 3

A micro/mesoporous ZSM-5/MCM-41 catalyst with tunable porosity and a high zeolitic character was formed by disintegrating 2 g of ZSM-5 having a Si/Al ratio of 27:1 in 55 ml of 0.2M NaOH. The disintegration was performed under gradual heating (without stirring) at 100° C. for 24 hours in the presence of CTAB (4.45%). Next, the mixture was cooled down and then the pH was adjusted to 9.0 through the addition of dilute sulfuric acid (2N). The mixture was then stirred for 24 h and then aged at 100° C. for another 24 h to form a ZSM-5/MCM-41 composite.

The solid product was then filtered, washed thoroughly using distilled water, dried at 80° C. overnight, and then calcined at 550° C. for 6 h to remove the surfactant. The resultant composite was ion-exchanged three times with 0.05M NH₄NO₃ solution at 80° C. for 2 hours, and then calcined at 550° C. for 2 h. The resulting powder was sieved to a particle size between 0.5 mm and 1.0 mm and then used as an additive to enhance the yield of propylene from catalytic cracking of vacuum gas oil (VGO).

The mesoporous content in the ZSM-5/MCM-41 composite was found to be 19 wt %. The specific surface area, pore diameter and the total pore volume are shown in Table 1 of FIG. 2. The ZSM-5/MCM-41 composite had a Si/Al ratio of 8.5:1, as determined by atomic absorption measurements. The XRD pattern showed the transformation of the zeolitic phase into a biphase containing both ZSM-5 and MCM-41. The material showed a d spacing value of 3.85 nm. The presence of intense peaks of ZSM-5 diffraction patterns, compared to MCM-41, shows a dominant zeolitic character in the composite. The surface area, pore volume and pore diameter, as measured by nitrogen adsorption, were 404 m²/g, 0.17 cm³/g and 2.4 nm, respectively.

### Example 4

A ZSM-5/MCM-41 composite with a biporous character was synthesized similar to that described above in Example 3, except that 2 g of H-ZSM-5 was disintegrated in 55 ml of 0.7M NaOH. The resulting powder was then sieved to a particle size between 0.5 mm and 1.0 mm and used as an additive to enhance the yield of propylene from catalytic cracking of vacuum gas oil (VGO). The specific surface area, pore diameter and the total pore volume are shown in Table 1 of FIG. 2. The resultant ZSM-5/MCM-41 composite with a biporous character had a Si/Al ratio of 12:1, as determined by atomic absorption measurements. The XRD pattern showed the transformation of the zeolitic phase into a biphase containing an equally intense XRD pattern corresponding to MCM-41 and ZSM-5 phases. The material showed a d spacing value of 4.06 nm. The presence of intense peaks of ZSM-5 diffraction patterns, along with MCM-41, shows the dominant biporous character in the composite. The mesoporous content in the ZSM-5/MCM-41 composite was found to be 47 wt %. The surface area, pore volume and pore diameter, as measured by nitrogen adsorption, were 468 m²/g, 0.25 cm³/g and 2.4 nm, respectively.

### Example 5

A ZSM-5/MCM-41 composite with a high mesoporous character was synthesized similar to that described above in Example 3, except that 2 g of H-ZSM-5 was first disintegrated in 55 ml of 1.0M NaOH. The mesoporous content in the ZSM-5/MCM-41 composite was found to be 96 wt %. The specific surface area, pore diameter and the total pore volume are shown in Table 1 of FIG. 2. The resultant ZSM-5/MCM-41 composite with a biporous character had a Si/Al ratio of 13:1, as determined by atomic absorption measurements. The XRD pattern showed the increased intensity of the hexagonal phase, and the decreased intensity of characteristic peaks of ZSM-5 in the composite. The material showed a d spacing value of 3.78 nm. The presence of intense peaks of ZSM-5 diffraction patterns, compared to MCM-41, shows the dominant zeolitic character in the composite. The surface area, pore volume and pore diameter, as measured by nitrogen adsorption, were 714 m²/g, 0.82 cm³/g and 2.7 nm, respectively.

### Example 6

In order to form mesoporous MCM-41 from a zeolitic seed, 2 g of ZSM-5 (with a Si/Al ratio 27:1) was dissolved completely by stirring in 55 ml of 0.7M NaOH (with a pH of 13.0) at 100° C. for 2 hours, in the presence of CTAB (4.45%). The mixture was then cooled down and the pH was adjusted to 9.0 through the addition of dilute sulfuric acid (2N). The mixture was then stirred for another 24 h and then aged at 100° C. for a further 24 h. The solid product was then filtered and calcined at 550° C. for 6 h to remove the surfactant. The resulting composite was ion-exchanged three times with 0.05M NH₄NO₃ solution at 80° C. for 2 hours, and then calcined at 550° C. for 2 hours. The specific surface area, pore diameter and the total pore volume are shown in Table 1 of FIG. 2.

The resultant MCM-41 had a Si/Al ratio of 13:1, as determined by atomic absorption measurements. The XRD pattern showed the presence of three well resolved peaks at the lower angle (20) region between 2° and 5° indexed to (100), (110), and (200) reflections, thus showing the presence of characteristic long range ordered hexagonal symmetry. The absence of any Bragg peaks corresponding to the zeolitic phase at higher angles indicates that the synthesized material is in a pure mesophase. The material showed a d spacing value of 3.86 nm. The presence of intense peaks of ZSM-5 diffraction patterns, compared to MCM-41, shows the dominant zeolitic character in the composite. The surface area, pore volume and pore diameter, as measured by nitrogen adsorption, were 527 m²/g, 0.72 cm³/g and 2.2 nm, respectively.

### Example 7

The ZSM-5/MCM-41 composite produced in Example 6 was further subjected to steaming (100% steam) in a fixed-bed for 4 h at 650° C. and at atmospheric pressure. The specific surface area, pore diameter and the total pore volume are shown in Table 1 of FIG. 2. The MCM-41 produced from zeolitic seed had a Si/Al ratio of 13:1, as determined by atomic absorption measurements. The XRD pattern of the steamed sample shows the characteristic diffractions peaks of hexagonal pore channels, indicating retention of the mesophase along with microporous ZSM-5. The material showed a d spacing value of 3.50 nm. The presence of intense peaks of ZSM-5 diffraction patterns, compared to MCM-41, shows the dominant zeolitic character in the composite. The surface area, pore volume and pore diameter, as measured by nitrogen adsorption, were 365 m²/g, 0.26 cm³/g and 2.2 nm, respectively.

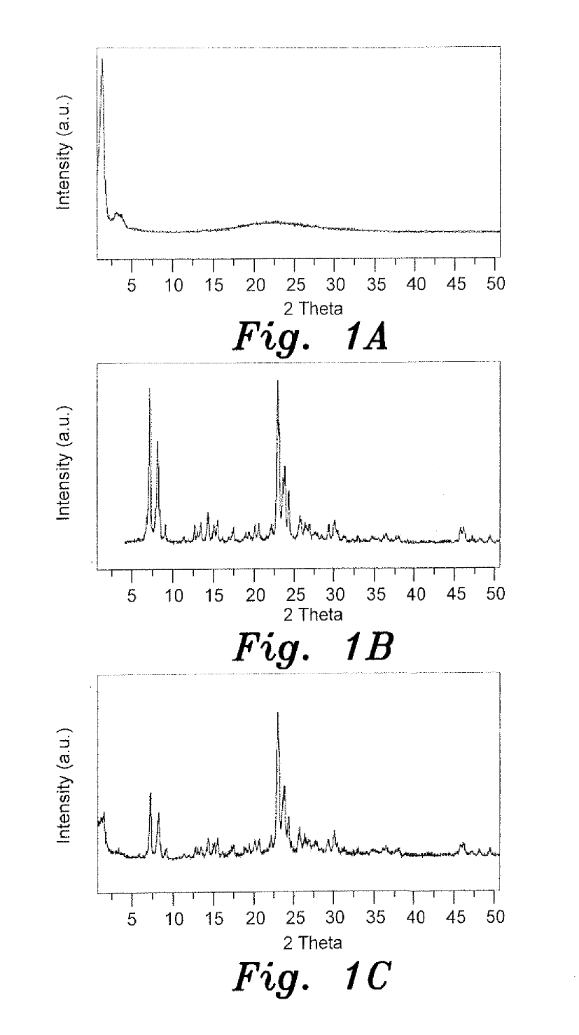

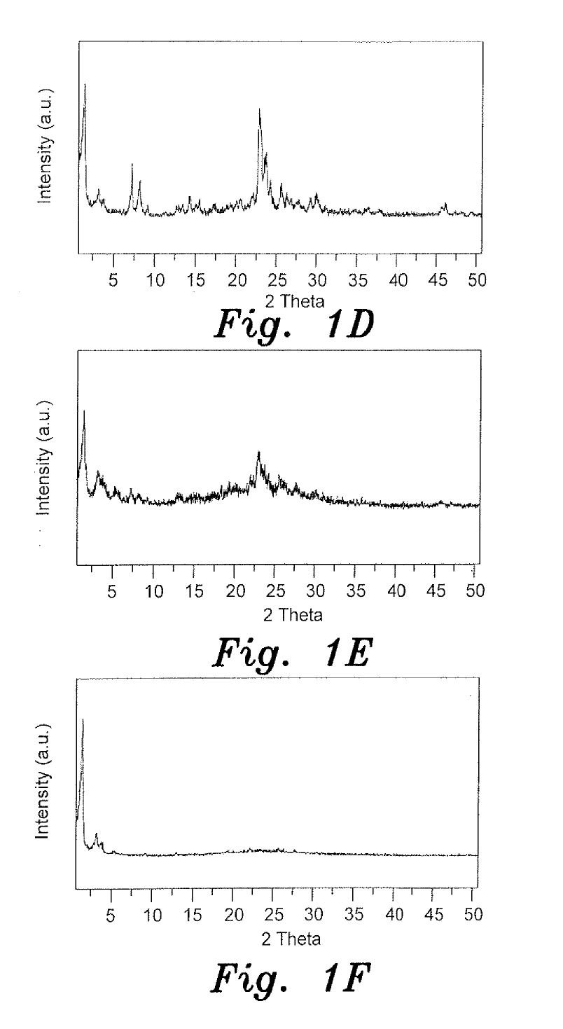

The XRD patterns of calcined AlMCM-41, ZSM-5 and ZSM-5/MCM-41 composites with different degrees of porosity obtained from ZSM-5 (with a SiO₂/Al₂O₃ ratio of 27:1) dissolution are shown in FIGS. 1A-1F. Specifically, FIG. 1A illustrates x-ray diffraction intensity as a function of angle for the AlMCM-41 of Example 1. FIG. 1B illustrates x-ray diffraction intensity as a function of angle for the ZSM-5 of Example 2. FIG. 1C illustrates x-ray diffraction intensity as a function of angle for the ZSM-5/MCM-41 with high microporous character of Example 3. FIG. 1D illustrates x-ray diffraction intensity as a function of angle for the ZSM-5/MCM-41 with biporous character of Example 4. FIG. 1E illustrates x-ray diffraction intensity as a function of angle for the ZSM-5/MCM-41 with high mesoporous character of Example 5. FIG. 1F illustrates x-ray diffraction intensity as a function of angle for the mesoporous MCM-41 synthesized from zcolitie seed of Example 6.

When the dissolution was carried out in 55 ml of 0.2M NaOH solution (the pH of the initial solution was approximately 12.10), the XRD pattern showed the transformation of the zeolitic phase into the biporous phase containing both ZSM-5 and MCM-41. In the low angle region (2-5°), an intense (100) peak, along with a less intense higher order diffraction peaks indexed to (110), (200) corresponding to MCM-41, were observed (as shown in FIG. 1C). Although the relative intensity of d₁₁₀ and d₂₀₀ reflections is less, which suggests a minor reduction of the mesoscopic order, the structure remains locally highly ordered. The presence of intense peaks of ZSM-5 diffraction patterns shows the dominant zeolitic character in the composite. When the alkaline condition increased with 0.7M NaOH (pH of approximately 13), the enhanced diffraction peaks at the lower angle region (2-5°) indicate an improved mesostructure formation, whereas higher angle peaks (8-50°) show the retention of the ZSM-5 structure (as shown in FIG. 1D). The presence of an equally intense XRD pattern corresponding to MCM-41 and ZSM-5 phases indicates the hiporous composite formation.

When the dissolution pH increased to 13.30 with 55 ml of 1.0M NaOH, the dissolution of greater amounts of ZSM-5 occurs. The intensity of the hexagonal phase increased, whereas the characteristic peaks of ZSM-5 became less intense but were still retained in the composite (as shown in FIG. 1E). FIG. 1F shows the XRD pattern of mesoporous MCM-41 containing fragments of ZSM-5 particles. In this case, the ZSM-5 phase disappears completely, due to complete dissolution of ZSM-5 in 55 ml of 0.7M NaOH solution by vigorous stirring at 100° C. for 2 hours. Although the XRD pattern was similar to that of conventional AlMCM-41 (which is assembled from the conventional precursors), such a dissolved ZSM-5 solution contains soluble aluminosilicate species with fragments of ZSM-5, monomeric aluminate and silicate species.

Comparatively, the presence of three well resolved peaks at the lower angle (20) region between 2° and 5° indexed to (100), (110), and (200) reflections shows the presence of characteristic long range ordered hexagonal symmetry. The absence of any Bragg peaks corresponding to the zeolitic phase at higher angles indicates that the synthesized material is in pure mesophase. The dissolution of ZSM-5 in the presence of a cationic surfactant stabilizes the zeolitic subunits through ion pairing and also serves as a structure-directing agent for the mesostructure formation. Thus, the present dissolution technique is useful in avoiding excessive dissolution of ZSM-5, which leads to the controlled formation of soluble aluminosilicate species, as well as unsolvable smaller ZSM-5 zeolite particles, which are subsequently used for the formation of mesoporosity.

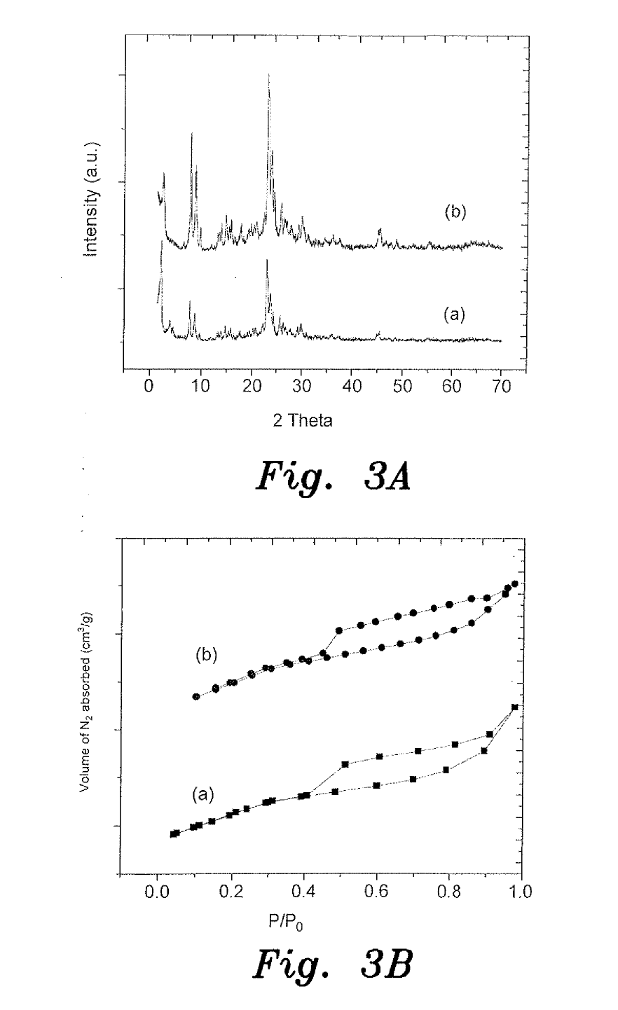

FIG. 3A shows a comparison in the XRD patterns of the ZSM-5/MCM-41 composite with the biporous character of Example 4 (indicated as (a) in FIGS. 3A and 3B) against those of the ZSM-5/MCM-41 composite after steaming of Example 7 (indicated as (b) in FIGS. 3A and 3B). FIG. 3B shows a comparison of nitrogen adsorption isotherms of the ZSM-5/MCM-41 composite with the biporous character of Example 4 against those of the ZSM-5/MCM-41 composite after steaming of Example 7. The composite sample was subjected to steaming (100% steam) in a fixed-bed for 4 h at 650° C. and at atmospheric pressure. The steam treatment makes it possible to determine the stability of the additive under the severe conditions present in the FCC regenerator. The XRD pattern of the steamed sample, shown in FIG. 3B, shows the characteristic diffractions peaks to that of hexagonal pore channels, indicating retention of the mesophase, along with microporous ZSM-5. The effect of steaming on the textural properties of steamed ZSM-5/MCM-41 showed that the mesoporous structures were quite well preserved with a high surface area (365 m²/g) and uniform pore size distributions (2.2 nm).

### Example 8

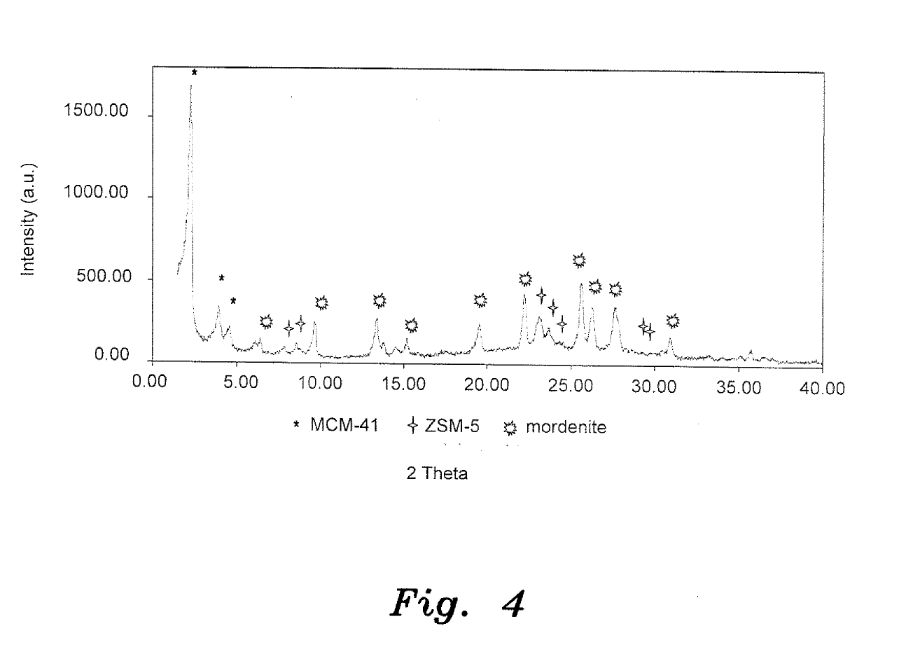

A triporous ZSM-5/mordenite/MCM-41 was also prepared by first dissolving ZSM-5 and mordenite, by hydrothermal heating, in 0.7M NaOH solution in the presence of CTAB. Following pH adjustment, a triporous composite was formed. The XRD of this composite sample is shown in FIG. 4.

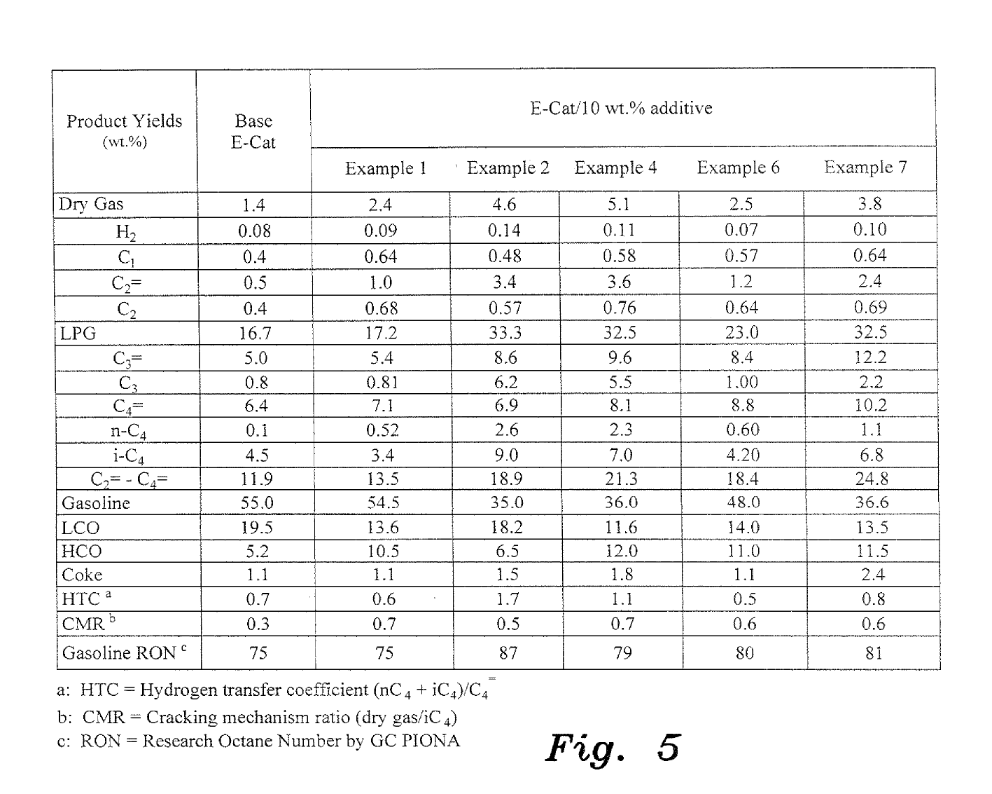

The samples of Example 1, Example 2, Example 4, Example 6 and Example 7 were tested as FCC catalyst additives to investigate the effect on the yield of propylene from catalytic cracking of Arabian Light hydrotreated vacuum gas oil (VGO) in a fixed-bed microactivity test (MAT) at 520° C. Their catalytic performance was assessed using a 10 wt % blend of the additives and a commercial equilibrium USY FCC catalyst (E-Cat) at various catalyst/oil ratios. Table 2 of FIG. 5 shows the product yields obtained from MAT at a constant conversion of 75%.

The MAT results show that the VGO cracking activity of E-Cat did not decrease by using these additives. The highest propylene yield of 12.2 wt % was achieved over the steamed biporous ZSM-5/MCM-41 composite of Example 7, compared with 8.6 wt % over the conventional ZSM-5 of Example 2 at similar gasoline yield penalty. Ethylene yield also increased to 2.4 wt % for the steamed biporous ZSM-5/MCM-41 composite compared with 0.5 wt % for base equilibrium catalyst. Steamed ZSM-5/MCM-41 gave a lower hydrogen transfer coefficient of 0.8. The enhanced production of propylene was attributed to the suppression of secondary and hydrogen transfer reactions and offered easier transport and accessibility to active sites. Gasoline quality was thus improved by the use of steamed ZSM-5/MCM-41.

It is to be understood that the present invention is not limited to the embodiments described above, but encompasses any and all embodiments within the scope of the following claims.

We claim:

1. A method of forming a hydrocarbon cracking catalyst, comprising the steps of:
performing a surfactant-mediated hydrolysis of ZSM-5 to form a solution;
adjusting the pH of the solution to selectively tune pore formation, wherein the pore formation is selected from the group consisting of microporous and mesoporous formation; and
hydrothermically condensing soluble aluminosilicates to form a mesoporous material over remaining ZSM-5 particles to form a ZSM-5/MCM-41 composite, whereby the ZSM-5/MCM-41 composite may be used as a hydrocarbon cracking catalyst.

2. The method of forming a hydrocarbon cracking catalyst as recited in claim 1, wherein the step of performing the surfactant-mediated hydrolysis of ZSM-5 to form the solution comprises disintegration of approximately ZSM-5 having a Si/Al ratio of about 27:1 in 0.2M NaOH in the presence of cetyltrimethylammonium bromide, wherein the hydrocarbon cracking catalyst has a high microporous characteristic.

3. The method of forming a hydrocarbon cracking catalyst as recited in claim 2, wherein the step of disintegrating the ZSM-5 in the NaOH in the presence of the cetyltrimethylammonium bromide is performed by gradual heating at about 100° C. for about 24 hours.

4. The method of forming a hydrocarbon cracking catalyst as recited in claim 3, wherein the step of adjusting the pH of the solution comprises adjusting the pH to about 9.0.

5. The method of forming a hydrocarbon cracking catalyst as recited in claim 4, wherein the step of adjusting the pH of the solution to approximately 9.0 comprises adding dilute sulfuric acid to the solution.

6. The method of forming a hydrocarbon cracking catalyst as recited in claim 5, further comprising the steps of:
filtering and washing the ZSM-5/MCM-41 composite to remove remaining surfactant; and
steaming the ZSM-5/MCM-41 composite.

7. The method of forming a hydrocarbon cracking catalyst as recited in claim 1, wherein the step of performing the surfactant-mediated hydrolysis of ZSM-5 to form the solution comprises disintegration of the ZSM-5 in 0.7M NaOH in the presence of cetyltrimethylammonium bromide, wherein the hydrocarbon cracking catalyst has a biporous characteristic.

8. The method of forming a hydrocarbon cracking catalyst as recited in claim 7, wherein the step of disintegrating the ZSM-5 in the NaOH in the presence of the cetyltrimethylammonium bromide is performed by gradual heating at about 100° C. for about 24 hours.

9. The method of forming a hydrocarbon cracking catalyst as recited in claim 8, wherein the step of adjusting the pH of the solution comprises adjusting the pH to about 9.0.

10. The method of forming a hydrocarbon cracking catalyst as recited in claim 9, wherein the step of adjusting the pH of the solution to approximately 9.0 comprises adding dilute sulfuric acid to the solution.

11. The method of forming a hydrocarbon cracking catalyst as recited in claim 10, further comprising the steps of filtering and washing the ZSM-5/MCM-41 composite to remove remaining surfactant.

12. The method of forming a hydrocarbon cracking catalyst as recited in claim 7, wherein the step of disintegrating the ZSM-5 in the NaOH in the presence of the cetyltrimethylammonium bromide is performed by heating at about 100° C. for about two hours.

13. The method of forming a hydrocarbon cracking catalyst as recited in claim 12, wherein the step of adjusting the pH of the solution comprises adjusting the pH to about 9.0.

14. The method of forming a hydrocarbon cracking catalyst as recited in claim 13, wherein the step of adjusting the pH of the solution to about 9.0 comprises adding dilute sulfuric acid to the solution.

15. The method of forming a hydrocarbon cracking catalyst as recited in claim 14, further comprising the steps of:
filtering and calcining the ZSM-5/MCM-41 composite to remove remaining surfactant;
ion exchanging the ZSM-5/MCM-41 composite with about 0.5M NH₄NO₃ solution;
calcining the ion-exchanged ZSM-5/MCM-41 composite; and
steaming the ZSM-5/MCM-41 composite.

16. The method of forming a hydrocarbon cracking catalyst as recited in claim 1, wherein the step of performing the surfactant-mediated hydrolysis of ZSM-5 to form the solution comprises disintegration of the ZSM-5 in 1.0M NaOH in the presence of cetyltrimethylammonium bromide, wherein the hydrocarbon cracking catalyst has a high mesoporous characteristic.

17. The method of forming a hydrocarbon cracking catalyst as recited in claim 16, wherein the step of disintegrating the ZSM-5 in the NaOH in the presence of the cetyltrimethylammonium bromide is performed by gradual heating at about 100° C. for about 24 hours.

18. The method of forming a hydrocarbon cracking catalyst as recited in claim 17, wherein the step of adjusting the pH of the solution comprises adjusting the pH to about 9.0.

19. The method of forming a hydrocarbon cracking catalyst as recited in claim 18, wherein the step of adjusting the pH of the solution to about 9.0 comprises adding dilute sulfuric acid to the solution.

20. The method of forming a hydrocarbon cracking catalyst as recited in claim 19, further comprising the steps of:
filtering and washing the ZSM-5/MCM-41 composite to remove remaining surfactant; and
steaming the ZSM-5/MCM-41 composite.
